(19) United States
(12) Patent Application Publication
(10) Pub. No.: US 2020/0257789 A1
(43) Pub. Date: Aug. 13, 2020

(54) IDENTITY VERFICATION METHOD, STORAGE MEDIUM AND ELECTRONIC DEVICE

(71) Applicant: Wuhan Jiyi Network Technology Co., Ltd, Wuhan (CN)

(72) Inventor: Guoqing CHEN, Wuhan (CN)

(73) Assignee: Wuhan Jiyi Network Technology Co., Ltd, Wuhan (CN)

(21) Appl. No.: 16/860,094

(22) Filed: Apr. 28, 2020

Related U.S. Application Data
(63) Continuation-in-part of application No. PCT/CN2019/100471, filed on Aug. 14, 2019.

(30) Foreign Application Priority Data
Dec. 28, 2018 (CN) 201811626563.6

(51) Int. Cl. G06F 21/36; G06F 3/0484

(52) U.S. Cl. CPC G06F 21/36; G06Q 50/265; G06F 3/04842; G06F 3/04847

(57) ABSTRACT

This invention releases a memory, an identity verification method, a system and devices. The identity verification method includes providing a CAPTCHA image including a slider and a predetermined path for the slider in a verification region; providing an operating instruction of the slider in a prompt region; generating a providing time and a providing location of a prompt indication according to a predetermined algorithm during an operation of the slider; providing the prompt indication according to the providing time and the providing location; receiving operation behavior on the slider and determines if the operation behavior satisfies the operating instruction; and generating a verification result according to the determined result. This invention prevents hackers from using malicious programs to stimulate legitimate users by brute force. It can effectively reduce the chance that the malicious bots pass the verification and improve the security of authentication.

### CROSS-REFERENCE TO RELATED APPLICATIONS

This application is a continuation-in-part of International Application No. PCT/CN2019/100471, filed on Aug. 14, 2019. This application also claims priority of Chinese Patent Application No. 201811626563.6, entitled “IDENTITY VERIFICATION METHOD, STORAGE MEDIUM, ELECTRONIC DEVICE AND EQUIPMENT” filed on Dec. 28, 2018, the entire contents of which are incorporated by reference herein.

### FIELD

The present invention relates to Internet information security field, and specifically to an identity verification method, a storage medium and an electronic device.

### BACKGROUND

A CAPTCHA, also referred to as a Completely Automated Public Turing test to tell Computers and Humans Apart, is an automated program for determining whether a human or a computer is entering identity verification information, thereby improving identity verification security.

By using CAPTCHA technology, malicious Internet behaviors such as password cracking, ticket scalping, and spam can be prevented.

As an important technology of human-computer verification, CAPTCHA technology has experienced many forms and technical innovations. The more popular types include text recognition challenge in early stage, as well as a method that collects the track of dragging the slider by a mouse. The later method breaks through the previous CAPTCHA of using static images by establishing behavioral models to determine whether the corresponding access track belongs to a real user or machine script. The track in this form of verification is usually collected from the starting point to the target position, which is approximately a straight track having about 220 pixels. If each pixel is corresponding to a track point, it needs to collect 220 track points at most.

According to the inventor's research, there are at least the following defects in the prior art. With the development of computer image recognition and processing technologies, the existing identity verification technology may be cracked, which reduce identity verification security.

The information disclosed in the background technologies section is only intended to increase the understanding of the overall background of the invention and shall not be deemed to acknowledge or in any way imply that the information constitutes prior art which is known to the general technical personnel in the field.

### SUMMARY OF INVENTION

In order to overcome the disadvantage of high probability of being cracked by the computer the existing identity verification technology, the present invention provides the an identity verification method, an identity verification system, a storage medium and an electronic device.

On the one hand, the present invention provides an identity verification method, the identity verification method including: providing a CAPTCHA image including a slider and a predetermined path for the slider in a verification region; providing an operating instruction of the slider in a prompt region; generating a providing time and a providing location of a prompt indication according to a predetermined algorithm during operation of the slider; providing the prompt indication according to the providing time and the providing location; receiving operation behavior on the slider and determines if the operation behavior satisfies the operating instruction; and generating a verification result according to the determined result.

Preferably, the prompt indication includes an interception line in the range of the predetermined path and is configured to prompt for a pause of the operation of the slider.

Preferably, the predetermined path includes at least two branches, and the prompt indication is configured to prompt a user to select one branch of the multiple branches during the operation of the slider.

Preferably, the prompt indication includes interception lines with different colors.

Preferably, the prompt indication is provided at least two times during the operation the slider.

Preferably, the prompt indication is configured to prompt a user to select an action from a group of pausing the operation of the slider, ending the operation of the slider, returning the slider back, changing the sliding direction of slider.

Preferably, the prompt indication is provided randomly during the operation of the slider.

Preferably, the operating instruction includes an operation way of the slider and a condition met during the operation.

On the other hand, the present invention provides an identity verification system including: an image providing module providing a CAPTCHA image including a slider and a predetermined path for the slider in a verification region, an operating instruction module providing an operating instruction of the slider in a prompt region, an algorithm module generating a providing time and a providing location of a prompt indication according to a predetermined algorithm during operation of the slider, a prompt providing module providing the prompt indication according to the providing time and the providing location, a determination module receiving operation behavior on the slider and determines if the operation behavior satisfies the operating instruction, and a result generation module generating a verification result according to the determined result.

Another aspect of the invention disclosed herein includes a storage medium storing one or more computer-executable instructions, the one or more computer executable instructions configured to perform an identity verification method when executed by at least one processor of an electronic device, the method including: providing a CAPTCHA image including a slider and a predetermined path for the slider in a verification region, providing an operating instruction of the slider in a prompt region, generating a providing time and a providing location of a prompt indication according to a predetermined algorithm during operation of the slider, providing the prompt indication according to the providing time and the providing location, receiving operation behavior on the slider and determines if the operation behavior satisfies the operating instruction, and generating a verification result according to the determined result.

A further aspect of the invention disclosed herein includes an electronic device, the electronic device including: at least one processor; and a storage medium storing one or more computer-executable instructions that, when executed by the at least one processor, cause the at least one processor to: provide a CAPTCHA image including a slider and a predetermined path for the slider in a verification region; provide an operating instruction of the slider in a prompt region; generate a providing time and a providing location of a prompt indication according to a predetermined algorithm during operation of the slider; provide the prompt indication according to the providing time and the providing location; receive operation behavior on the slider and determines if the operation behavior satisfies the operating instruction; and generate a verification result according to the determined result.

In the above verification method, system, storage medium and electronic device, it can not only load a verification image with a predetermined path and a draggable slider but also remind users so they can change the movement of the slider by a pause or choosing other paths. In this way, the user's operation to the sliders is not limited to the path that is available to drag the slider. User's actions in random times and locations prevent a malicious program from stimulating legitimate users by brute force.

Furthermore, a sliding path of a slider in current CAPTCHA technologies in prior art is a straight line by dragging the slider complete the puzzle. Since the verified responses are straight tracks with different lengths, bad actors can use malicious programs to obtain the right results by attempting with all straight lines of different lengths. As a result, malicious programs have a high possibility to crack the CAPTCHAs that use the current technologies. However, the present invention can prevent malicious programs from stimulating legitimate users by brute force. It can effectively reduce the chance of using malicious bots to pass the verification and improve the security of authentication.

### BRIEF DESCRIPTION OF THE DRAWINGS

One or more embodiments are illustrated by the figures and not limited to the specific examples of the figures. Components with the same reference numbers are similar. Unless specifically stated, the components in the drawings are not necessarily drawn to scale.

FIG. 1 is a flow chart of an identity verification method in one embodiment.

FIG. 2 is a schematic diagram of a CAPTCHA image including a slider, a predetermined path for the slider, and an operating instruction of the slider according to one embodiment.

FIG. 3 is another schematic diagram of the CAPTCHA image.

FIG. 4 is also another schematic diagram of the CAPTCHA image.

FIG. 5 is a structural schematic diagram of a system to perform the verification in one embodiment.

FIG. 6 is a schematic structural diagram of electronic devices to perform the verification in one embodiment.

### DETAILED DESCRIPTION

In order to provide a clear understanding of the objects, features, and advantages of the embodiments, the following are detailed and complete descriptions to the technological solutions adopted in the embodiments. Obviously, the descriptions are part of the whole embodiments. The other embodiments which are not processed creatively by technicians of ordinary skills in the field are under the protection of this invention. The same is given with reference to the drawings and specific embodiments. It should be noted that non-conflicting embodiments in the invention and the features in the embodiments may be combined with each other without conflict.

In the following description, numerous specific details are set forth in order to provide a full understanding of the invention. The invention may be practiced otherwise than as described herein. The following specific embodiments are not to limit the scope of the invention.

Unless defined otherwise, all technical and scientific terms herein have the same meaning as used in the field of the art as generally understood. The terms used in the invention are to describe particular embodiments and are not intended to limit the invention.

The invention, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be executed as either software and/or hardware modules and can be stored in any type of non-transitory computer-readable medium or another storage medium. Some non-limiting examples of non-transitory computer-readable media include CDs, DVDs, BLU-RAY, flash memory, and hard disk drives.

### Embodiment 1

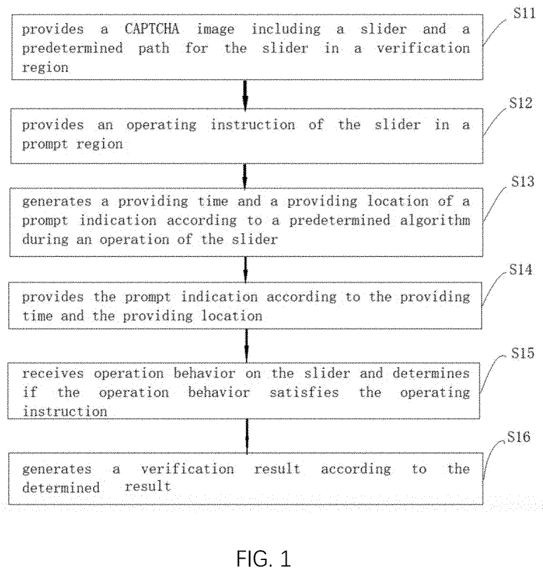

FIG. 1 shows a flowchart diagram of one embodiment of an identity verification method. The method may be executed by at least one electronic device, such as network devices, terminals, and servers including single server, server clusters, The method may be installed on software or hardware of the electronic device and includes the following steps S11-S16.

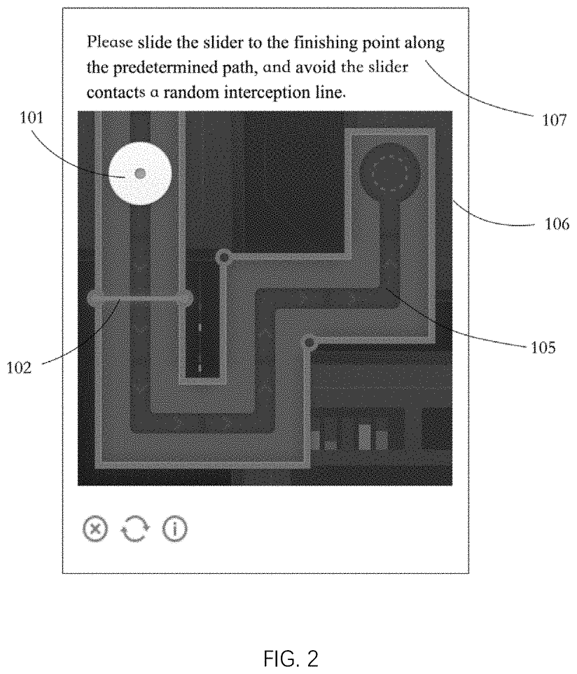

In step S11, the at least one electronic device provides a CAPTCHA image including a slider 101 (as shown in FIG. 2) and a predetermined path 105 (as shown in FIG. 2) for the slider 101 in a verification region 106 (as shown in FIG. 2). The predetermined path 105 may be a track of the slider 101 by moving a mouse according to an operating instruction of the slider 101. In the embodiment of FIG. 2, the slider 101 may be the round shape and located at a starting point of the predetermined path 105. However, in other embodiment, the slider 101 may have other shapes.

In the step S12, the at least one electronic device provides an operating instruction of the slider 101 in a prompt region 107. The operating instruction may include an operation way of the slider 101 and a condition met during the operation. In the embodiment of FIG. 2, the prompt region 107 is adjacent to the verification region 106, and the operation instruction is “Please slide the slider to the finishing point along the predetermined path, and avoid the slider contacts a random interception line”, in which the condition is “avoid the slider contacts a random interception line”.

In the step S13, a providing time and a providing location of an indication are generated based on a predetermined algorithm during the operation of the slider 101. In the embodiment, the indication that can be text or graph provides real-time prompt during the operation of the slider 101. As shown in FIG. 2, the indication as random interception lines is configured to prompt for a pause of the operation of the slider 101. The prompt indication may appear many times during the operation the slider, and the providing time and the providing location of each indication may be different from others for increasing the difficulty of CAPTCHA cracking.

in the step S14, the at least one electronic device provides the prompt indication according to the providing time and the providing location in the predetermined path 105. It can be understood, the CAPTCHA image and the operating instruction are provided firstly. Secondly, the slider is operated, and the providing time and the providing location of the prompt indication are generated by the predetermined algorithm during the operation of the slider. Thirdly, the prompt indication is provided in the predetermined path 105 according to the providing location of the prompt indication.

In the step S15, the at least one electronic device receives operation behavior on the slider and determines if the operation behavior match the operating instruction. On the one hand, it is determined that if a real sliding path of the slider according to the operation behavior satisfies the operation way of the operating instruction. On the other hand, it is determined that if a feedback action of the operation behavior meet the requirement of the operating instruction during the operation of the slider. As shown in FIG. 2, the feedback action of the operation behavior is a pause of the operation on the slider 101 when the intercept line appears, and it can be obtained by determining if the slider 101 touches the interception line.

In the step S16, the at least one electronic device generates a verification result according to the determined result. When the verification result is “YES”, it is considered that the operation behavior is provided by a human and the verification passes. When the verification result is “NO”, it is considered that the operation behavior is not provided by a human and the verification fails.

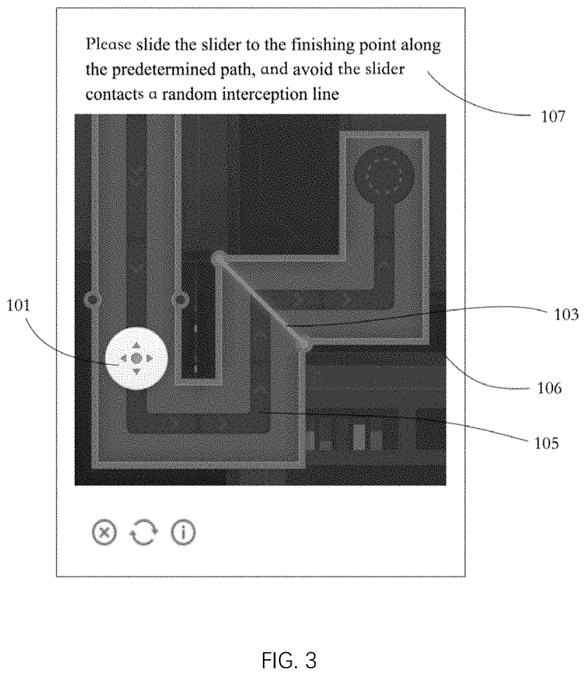

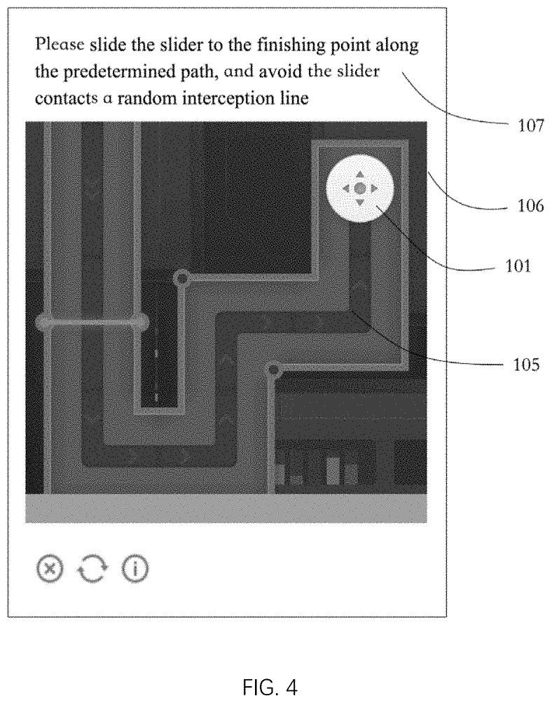

As shown in FIGS. 2-4, a CAPTCHA image of the verification region changes at different times during the verification process. Firstly, in FIG. 2, when a first interception line 102 appears, the operation of the slider 101 needs to be stopped to avoid the slider touching the first interception line 102. When the first interception line 102 disappears, the users can continue to drag the slider 101 to the end. Secondly, in FIG. 3, a second interception line 103 appears and the operation on the slider 101 needs to be stopped again. When the second interception line 103 disappears, the users can continue to drag the slider 01 to the end and finish the verification.

In the application of the embodiment, the indication can be configured to prompt a user to pause or end the operation, return the slider back, change sliding direction, and so on. The indication may have various forms, such as different colors. For example, when a red interception line appears, the users need to pause the operation, and when the red disappear, they can continue the operation.

In this embodiment, the predetermined path may include a plurality of branches, and the indication is configured to prompt a user to select one branch during the operation of the slider. In other word, due to different locations of the indication, there are different selections of the path to drag the slider to the end. The verification result can be generated according to the selection of the branches by the user.

Besides preset paths and slider images, this embodiment provides an indication that requires users to pause the dragging or choose a different path. In this way, the operation of the slider not only includes sliding the slider but also feedback actions in random times and locations, so malicious program can hardly crack it.

Furthermore, a sliding path of a slider in current CAPTCHA technologies in prior art is a straight line by dragging the slider to complete the puzzle. Since the verified responses are straight tracks with different lengths, malicious programs can attempt every straight line with various lengths to obtain the right result. As a result, malicious programs have a high possibility to crack the CAPTCHAs that use the current technologies. However, the embodiments of the present invention prevent malicious programs from stimulating legitimate users by brute force. It can effectively reduce the chance that the malicious bots pass the verification and improve the security of authentication.

### Embodiment 2

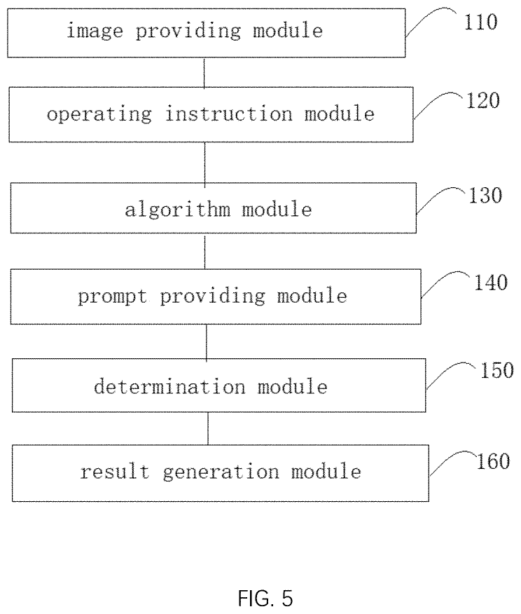

FIG. 5 is a schematic structural diagram of a system to implement CAPTCHA in the embodiment. The system is configured to execute the method to implement the CAPTCHA mentioned in embodiment 1. The system can be regarded as a virtual device consisting of various virtual modules which achieve their function by network devices, terminals, and servers.

In at least one embodiment, the identity verification system includes an image providing module 110, an operating instruction module 120, an algorithm module 130, a prompt providing module 140, a determination module 150 and a result generation module 160.

The image providing module 110 is configured to provide a CAPTCHA image including a slider and a predetermined path for the slider in a verification region. The predetermined path may be a track of the slider 101 by moving a mouse according to an operating instruction of the slider. In the embodiment of FIG. 2, the slider 101 may be the round shape and located at a starting point of the predetermined path 105. However, in other embodiment, the slider 101 may have other shapes.

The operating instruction module 120 is configured to provide an operating instruction of the slider in a prompt region. The operating instruction may include an operation way of the slider 101 and a condition met during the operation. In the embodiment of FIG. 2, the prompt region 107 is adjacent to the verification region 106, and the operation way is “Please slide the slider to the finishing point along the predetermined path, and the condition is “avoid the slider contacts a random interception line”.

The algorithm module 130 is configured to generate a providing time and a providing location of a prompt indication according to a predetermined algorithm during operation of the slider. In the embodiment, the prompt indication is real time information for the operation of the slider, and may include prompt text or prompt graph. As shown in FIGS. 2-4, the prompt indication may include random interception lines 102, 103 and 104, and is configured to prompt for a pause of the operation of the slider 101. The prompt indication may appear many times during the operation the slider, and the providing time and the providing location of each prompt indication may be different from others for increasing cracking difficulty of the CAPTCHA image.

The prompt providing module 140 is configured to provide the prompt indication according to the providing time and the providing location. It can be understood, the CAPTCHA image and the operating instruction are provided firstly. Secondly, the slider is operated, and the providing time and the providing location of the prompt indication are generated according to the predetermined algorithm during the operation of the slider. Thirdly, the prompt indication is provided.

The determination module 150 is configured to receive operation behavior on the slider and determines if the operation behavior satisfies the operating instruction. On the one hand, it is determined that if a real sliding path of the slider according to the operation behavior satisfies the operation way of the operating instruction. On the other hand, it is determined that if a feedback action of the operation behavior satisfies the condition of the operating instruction during the operation of the slider. As shown in FIG. 2, the feedback action of the operation behavior is a pause of the operation on the slider 101 during the interception line 102 appears, and it can be obtained by determining if the slider 101 contacts the interception line 102.

The result generation module 160 is configured to generate a verification result according to the determined result. When the verification result is “YES”, it is consider that the operation behavior is provided by a human and the verification passes. n the verification result is “NO”, it is consider that the operation behavior is not provided by a human.

In the identity verification system according to above embodiment, the prompt indication can be provided during the operation of the slider, such that the operation of the slider not only includes sliding the slider, but also feedback actions in random times and locations, such that above identity verification system is hard to be cracked.

Furthermore, a sliding path of a slider in some identity verification technologies may be a direct line, a malicious program can attempt all of the direct lines to obtain a pass result, such that the sliding path verification may be easy to be cracked. However, in identity verification system, according to the above embodiments, due to the prompt indication, it is hard to finish the feedback actions by malicious program, and identity verification security can be improved.

### Embodiment 3

The embodiment provides a non-transitory (iron-volatile) computer storage medium. It stores computer-executable instructions that can execute all the steps to implement the identity verification method mentioned in the above embodiments and achieve the same effect.

### Embodiment 4

The embodiment provides an electronic device to implement the CAPTCHA. The electronic device includes storage medium with a corresponding computer program which can execute all the steps to implement the identity verification method mentioned in the above embodiments and achieve the same effect.

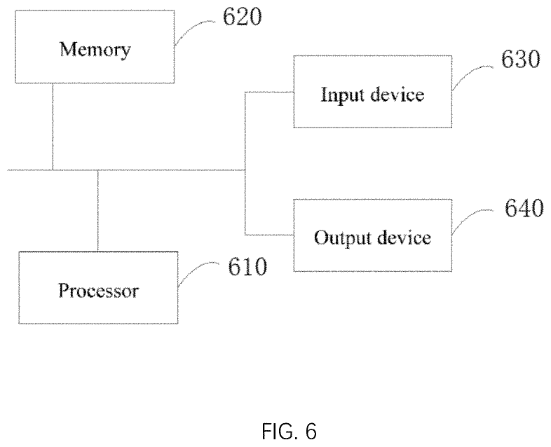

As shown in FIG. 6, the terminal includes one or more processors 610 and a memory 620. One processor 610 is taken as an example in FIG. 6. The terminal may further include an input device 630 and an output device 640.

The processor 610, the memory 620, the input device 630 and the output device 640 can be connected via a bus or in another mode, taking bus connection as an example in FIG. 6.

The memory 620 serving as a non-volatile computer-readable storage medium can be used for storing non-volatile software programs, non-volatile computer-executable programs and modules. The processor 610 runs the non-volatile software programs, instructions and modules stored in the memory 620 to execute various functions and data processing of the terminal, i.e., to implement the processing method in above method embodiments.

The memory 620 may include a program storage area and a data storage area, wherein the program storage area can store an operating system and an application required by at least one function; and the data storage area can store data and the like. Moreover, the memory 620 may include a high-speed random-access memory, and may also include non-volatile memory, e.g., at least one disk storage medium, a flash memory device or other non-volatile solid-state storage media. In some embodiments, the memory 620 may include memories arranged remotely relative to the processor 610, and these remote memories can be connected to the processor via a network. The example of the network includes but not limited to the internet, an intranet, a local area network, a mobile communication network and a combination thereof.

The input device 630 can receive input digital or character information and generate signal input. The output device 640 may include display equipment such as a display screen.

The one or more processors 610 execute the one or more modules stored in the memory 620. The following is the steps of execution by the one or more processors 610: providing a CAPTCHA image including a slider and a predetermined path for the slider in a verification region; providing an operating instruction of the slider in a prompt region; generating a providing time and a providing location of an indication according to a predetermined algorithm during operation of the slider; providing the indication according to the providing time and the providing location, receiving operation behavior on the slider and determines if the operation behavior matches the operating instruction; and generating a verification result according to the determined result.

Above product can execute the methods provided by the embodiments of the invention. The product has corresponding functions and effects. For the technical details not described in detail in this embodiment, reference may be made to the methods provided by the embodiments of the invention.

The electronic device in the embodiments of the invention exists in multiple forms, including but not limited to:

Mobile communication equipment: this type of equipment is characterized by a mobile communication function and has the main goals of providing voice and data communication. The terminal includes a smartphone (e.g., iPhone), a multimedia phone, a functional phone, a low-end phone, etc.

Ultra-mobile personal computer equipment: this type of equipment belongs to the scope of personal computers, has computing and processing functions, and generally also has mobile internee characteristics. The terminal includes PAD, an MID (Mobile Internet Device) and UMPC (Ultra Mobile Personal Computer) equipment and the like, e,g., iPad.

Portable entertainment equipment: this type of equipment can display and play multimedia contents. The equipment includes audio and video players iPod), a handheld game player, an electronic book, an intelligent toy and portable vehicle-mounted navigation equipment.

Server: equipment for providing computing services, including a processor, a hard disk, a memory, a system bus, etc., wherein the architecture of the server is similar to that of a general computer, but the server is highly required on the aspects of processing capability, stability, reliability, security, expandability, manageability and the like because it needs to provide highly reliable services.

Other electronic devices with a data interaction function.

Above-described device embodiments are only schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs.

Upon the descriptions of above embodiments, those skilled in the art can clearly learn that each embodiment can be realized by means of software and a general hardware platform, and of course, can be realized via hardware. Based on such an understanding, above technical solutions substantially or the parts making a contribution to relevant technologies may be embodied in the form of a software product, and the computer software product can be stored in a computer-readable storage medium, such as a ROM (Read-Only Memory)/RAM (Random Access Memory), a magnetic disk, an optical disk, etc., which includes a plurality of instructions enabling computer equipment (which may be a personal computer, a server, or network equipment or the like) to execute each embodiment of the method in some part of each embodiment.

Finally, it should be noted that above embodiments are merely used for illustrating the technical solutions of the invention, rather than limiting the invention; though the invention is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the invention.

What is claimed is:

1. An identity verification method, comprising:
providing a CAPTCHA image including a slider and a predetermined path for the slider in a verification region;
providing an operating instruction of the slider in a prompt region;
generating a providing time and a providing location of a prompt indication according to a predetermined algorithm during operation of the slider;
providing the prompt indication according to the providing time and the providing location;
receiving operation behavior on the slider and determines if the operation behavior satisfies the operating instruction; and
generating a verification result according to the determined result.

2. The method according to claim 1, wherein the prompt indication comprises an interception line in the range of the predetermined path and is configured to prompt for a pause of the operation of the slider.

3. The method according to claim 1, wherein the predetermined path comprises at least two branches, and the prompt indication is configured to prompt a user to select one branch of the at least two branches during the operation of the slider.

4. The method according to claim 1, wherein the prompt indication comprises interception lines with different colors.

5. The method according to claim 1, wherein the prompt indication is provided at least two times during the operation the slider.

6. The method according to claim 1, wherein the prompt indication is configured to prompt a user to select an action from a group of pausing the operation of the slider, ending the operation of the slider, returning the slider back, changing the sliding direction of slider.

7. The method according to claim 1, wherein the prompt indication is provided randomly during the operation of the slider.

8. The method according to claim 1, wherein the operating instruction comprises an operation way of the slider and a condition met during the operation.

9. A storage medium storing one or more computer-executable instructions, the one or more computer-executable instructions configured to perform an identity verification method when executed by at least one processor of an electronic device, the method comprising:
providing a CAPTCHA image including a slider and a predetermined path for the slider in a verification region;
providing an operating instruction of the slider in a prompt region;
generating a providing time and a providing location of a prompt indication according to a predetermined algorithm during an operation of the slider, the indication provides real-time instructions to the users when they drag the slider,
providing the prompt indication according to the providing time and the providing location;
receiving operation behavior on the slider and determines if the operation behavior satisfies the operating instruction; and
generating a verification result according to the determined result.

10. The storage medium according to claim 9, wherein the prompt indication comprises an interception line in the range of the predetermined path and is configured to prompt for a pause of the operation of the slider.

11. The storage medium according to claim 9, wherein the predetermined path comprises at least two branches, and the prompt indication is configured to prompt a user to select one branch of the two branches during the operation of the slider.

12. The storage medium according to claim 9, wherein the prompt indication comprises interception lines with different colors.

13. The storage medium according to claim 9, wherein the prompt indication is provided at least two times during the operation the slider.

14. The storage medium according to claim 9, wherein the prompt indication is configured to prompt a user to select an action from a group of pausing the operation of the slider, end the operation of the slider, returning the slider back, changing sliding direction of slider.

15. An electronic device comprising:
at least one processor; and
a storage medium storing one or more computer executable instructions that, when executed by the at least one processor, cause the at least one processor to:
provide a CAPTCHA image including a slider and a predetermined path for the slider in a verification region;
provide an operating instruction of the slider in a prompt region;
generate a providing time and a providing location of a prompt indication according to a predetermined algorithm during operation of the slider;
provide the prompt indication according to the providing time and the providing location;
receive operation behavior on the slider and determines if the operation behavior satisfies the operating instruction; and
generate a verification result according to the determined result.

16. The electronic device according to claim 15, wherein the prompt indication comprises an interception line in the range of the predetermined path and is configured to prompt for a pause of the operation of the slider.

17. The electronic device according to claim 15, wherein the predetermined path comprises at least two branches, and the pro indication is configured to prompt a user to select one branch of the two branches during the operation of the slider.

18. The electronic device according to claim 15, wherein the prompt indication comprises interception lines with different colors.

19. The electronic device according to claim 15, wherein the prompt indication is provided at least two times during the operation the slider.

20. The electronic device according to claim 15, wherein the prompt indication is configured to prompt a user to select an action from a group of pausing the operation of the slider, end the operation of the slider, returning the slider back, changing sliding direction of slider.
